(19) United States
(12) Patent Application Publication
(10) Pub. No.: US 2004/0134079 A1
(43) Pub. Date: Jul. 15, 2004

(54) Ice cream spoon

(76) Inventors: Mathieu Lion, Paris (FR); Lucas Bignon, Cachan (FR)

Correspondence Address: Mark Montague, Cowan, Liebowitz & Latman, P.C., 1133 Avenue of the Americas, New York, NY, 10036, US

(21) Appl. No.: 10/732,597

(22) Filed: Dec. 10, 2003

(30) Foreign Application Priority Data
Jan. 9, 2003 (EP) 03290046.6

(51) Int. Cl. A47J 43/28

(52) U.S. Cl. 30/324

(57) ABSTRACT

An ice cream spoon having a handle bearing a generally hemispherical cup that includes a deformable bottom part made of a deformable flexible material.

### FIELD OF THE INVENTION

The present invention relates to the field of kitchen utensils. Still more precisely, the invention relates to an ice cream spoon, also known as an ice cream scoop.

### BACKGROUND OF THE INVENTION

The field of kitchen utensils and particularly ice cream spoons has given rise to an abundant amount of literature. In particular, the following patent documents relate to this field: FR A 911 080, FR A 927 874, FR A 933 163, FR A 968 190, EP A 0 331 520, BE A 1 010 281, U.S. Pat. No. 4,161,381, U.S. Pat. No. 4,699,582, U.S. Pat. No. 4,392,806, DEA 36 22 034.

As understood in reading the aforementioned documents, the majority of ice cream spoons which are offered have a handle which bears a rigid, generally hemispherical cup and a mobile lever or scraper placed in the cup, generally mounted so as to pivot in it, and associated with some means of actuation in order to unstick the ball of ice cream contained in the cup.

### OBJECTS AND SUMMARY OF THE INVENTION

It is an object of the present invention to improve the design of ice cream spoons. It is a particular object to provide an ice cream spoon with a novel design that enables a user to easily dislodge a scoop of ice cream from it.

These objects are attained in the context of the present invention by an ice cream spoon which has a handle bearing a generally hemispherical cup, and wherein the cup has a bottom part that is made of deformable flexible material.

As will be specified subsequently, the spoon according to the present invention, due to the presence of the bottom part made of deformable flexible material, particularly allows for easy removal of the contents of the cup.

Various other objects, advantages and features of the present invention will become readily apparent to those of ordinary skill in the art, and the novel features will be particularly pointed out in the appended claims.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 schematically illustrates an external side view of an ice cream spoon according to the present invention; and

FIG. 2 schematically illustrates a view in longitudinal section of the ice cream spoon according to the present invention.

### DETAILED DESCRIPTION OF THE INVENTION

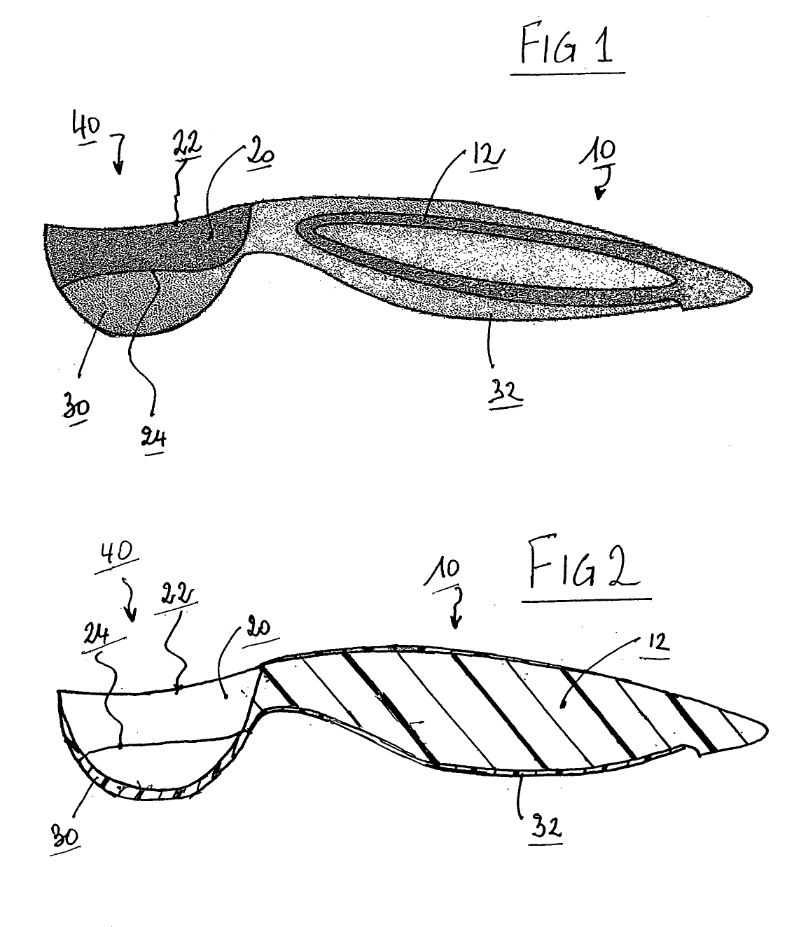

FIGS. 1 and 2 show an ice cream spoon that includes an elongated rigid handle 10 and a generally hemispherical cup 40. Preferably, the spoon has a longitudinal plane of symmetry passing through the plane of section which coincides with the plane of FIG. 2. Handle 10 is connected by one end to rigid frame 20 in the form of a closed ring. Its edges can be slightly curved or wavy. Edge 22 of ring 20, called the “upper edge” in the context of the present invention, delimits the opening contour of generally hemispherical cup 40. Its bottom is formed by sphere portion 30 of spherical geometry made of deformable, flexible and preferably elastic material. It is connected on frame 20 at the site of its lower peripheral border 24.

Sphere portion 30, in combination with ring 20, forms an impervious hemispherical cup. Typically, sphere portion 30 covers a solid angle greater than 90 degrees and advantageously between 100 and 130 degrees.

Rigid frame 20 allows for easy extraction of ice cream from a reserve container. On this occasion, a ball of ice cream is housed in cup 40. It is then easy, due to the present invention, to remove the ball of ice cream and to transfer it from cup 40 to any appropriate place, bowl or equivalent, by deformation of sphere portion 30.

More precisely, in the context of the invention, handle 10 preferably has rigid insert 12 connected with frame or ring 20. Insert 12 is partially covered with envelope 32 made of flexible material. This is preferably made in the form of a single piece with flexible bottom 30.

The particular geometry of insert 12 and of flexible envelope 32 falls under ergonomic and aesthetic considerations. It will not be described in detail subsequently. Of course, it is not limited to the particular embodiment described in the appended figures.

The ice cream spoon according to the present invention represented in the figures can be produced according to different techniques.

According to a first implementation, the ice cream spoon according to the present invention can be produced using rigid frame 20 and flexible sphere portion 30 consisting of parts which are initially separate and then assembled.

As a non limiting example, frame 20 can in this context be formed out of metal, for example, out of steel, aluminum or zinc alloy, while sphere portion 30 is produced out of flexible material, for example, out of silicone or plastic material. The connection between rigid frame 20 and sphere portion 30 can be formed by any appropriate means, for example, by adhesive, welding, heat or ultrasound, riveting or equivalent.

However, in the context of the present invention, the spoon is preferably produced from a part made entirely of synthetic material, for example, plastic. It is in that case preferably produced by co-injection, co-extrusion, duplicate molding or equivalent.

Frame 20 can be formed of various materials such as ABS (acrylonitrile butadiene styrene), polycarbonate, polypropylenes, and sphere portion 30 may be produced out of various materials such as elastomers, rubber, silicone, and impervious textiles.

Insert 12 of the handle and rigid frame 20 are preferably produced out of polyethylene, and envelope 32 and flexible bottom 30 preferably are produced out of a thermoplastic elastomer.

The present invention however is not limited to the particular embodiment described but rather extends to any variant in accordance with its intent. Furthermore, the present invention is not limited to the materials indicated in the preceding. Moreover, the present invention is not limited for use as an ice cream spoon, but may be used to scoop other similar foods, including but not limited to ice milk, frozen yogurt, sherbet or other similar types of frozen foods. The present invention also may be used to “dish out” non-frozen items, including for example dough, chop-meat, etc. The present invention may further be utilized with non-food items.

The present invention in particular offers the advantage of being completely hygienic. In effect, contrary to the state of the art according to which the cup has a mobile lever or scraper which is always difficult to clean, the cup of the spoon according to the present invention which is intended to come in contact with the ice cream has no mobile part, hidden surface or zone which is difficult to access.

The present invention further advantageously allows a user to easily dislodge ice cream scooped up by the ice cream spoon of the present invention by pushing down onto the outer surface of the sphere portion 30 to deform this portion thus causing the ice cream to fall into a cup, bowl or other structure. Sphere portion 30 may be deformed by the use of the user's thumb or other finger, or other type of instrument. When depressed, and while the open side of the cup is facing downwards, the amount of surface area of the scoop of ice cream in contact with the interior of sphere portion 30 is substantially reduced thus enabling the ice cream to quickly dislodge and fall from the ice cream spoon of the present invention.

Therefore, it is intended that the appended claims be interpreted as including the embodiments described herein, the alternatives mentioned above, and all equivalents thereto.

What is claimed is:

1. A spoon preferably for use as an ice cream spoon, comprising:
a handle; and
a substantially hemispherical cup coupled to the handle, the cup including a deformable bottom part made of a deformable flexible material.

2. The spoon according to claim 1, further comprising a rigid frame in which the deformable cup is inserted, and wherein the handle is coupled to the rigid frame.

3. The spoon according to claim 2, wherein the deformable bottom part of the spoon is formed by a sphere portion connected to the rigid frame.

4. The spoon according to claim 1, wherein the deformable bottom part has a shape of a hemispherical sphere.

5. The spoon according to claim 1, wherein the deformable bottom part covers a solid angle greater than 90 degrees.

6. The spoon according to claim 1, further comprising a rigid frame in which the deformable cup is inserted, and wherein the handle is coupled to the rigid frame, and wherein the handle includes a rigid insert coupled to the rigid frame.

7. The spoon according to claim 6, wherein the rigid insert is partially covered with an envelope made of a flexible material.

8. The spoon according to claim 7, wherein the envelope is made in the form of a single piece with a flexible bottom.

9. The spoon according to claim 1, wherein both the handle and the cup are a single unit formed of a synthetic material.

10. The spoon according to claim 1, wherein the spoon is produced by co-injection, co-extrusion or duplicate molding.

11. The spoon according to claim 1, further comprising a rigid frame produced from polyethylene and in which the deformable cup is inserted, the handle being coupled to the rigid frame.

12. The spoon according to claim 1, wherein the handle includes a rigid insert produced out of polyethylene.

13. The spoon according to claim 1, wherein the flexible bottom part is produced out of a thermoplastic elastomer.

14. The spoon according to claim 1, wherein the cup has a frame made of a material selected from the group consisting of ABS (acrylonitrile butadiene styrene), polycarbonate, and polypropylenes, and the flexible bottom part is produced out of a material selected from the group consisting of elastomers, rubber, silicone, and impervious textiles.

15. The spoon according to claim 1, wherein the cup has a frame made out of metal, and the flexible bottom part is produced out of a flexible material selected from a group consisting of silicone and plastic material.

16. A method of dislodging a scoop of food item, comprising the steps of:
obtaining a spoon having a handle and a substantially hemispherical cup coupled to one end of the handle, the cup including a scoop of a food item;
position the spoon to provide an open end of the cup substantially below a closed end of the cup;
deforming a deformable part of the cup contained within the closed end of the cup to dislodge the scoop of food item from the cup so as to cause the scoop of food item to fall away from the cup.

17. The method of claim 16, wherein the step of obtaining a spoon is carried out by obtaining a spoon having a handle coupled to a rigid frame in which a deformable cup is inserted.
